(19) United States
(12) Patent Application Publication
(10) Pub. No.: US 2020/0113192 A1
(43) Pub. Date: Apr. 16, 2020

(54) PULL-APART MULTI-PORTION BAKED GOODS

(71) Applicant: King's Hawaiian Holding Company, Inc., Torrance, CA (US)

(72) Inventor: Jordan FRANK, Torrance, CA (US)

(21) Appl. No.: 16/573,638

(22) Filed: Sep. 17, 2019

Related U.S. Application Data
(60) Provisional application No. 62/732,444, filed on Sep. 17, 2018.

(51) Int. Cl. A21D 13/47; A47J 37/01; A47J 43/20; A21D 13/30; A21D 13/20; A21D 13/10; A21B 3/13

(52) U.S. Cl. CPC A21D 13/47; A47J 37/01; A47J 43/20; A21B 3/134; A21D 13/20; A21D 13/10; A21D 13/30

(57) ABSTRACT

The present invention relates to the formation of pull-apart multi-portion baked goods composed of multiple portions of dough or thick batter, including, but not limited to, bread dough or muffin batter. Specifically, the invention relates to a pull-apart multi-portion baked good developed by arranging the multiple portions of dough or batter such that the baking process creates minimal connections linking said portions and thus obtains better consistency among each portion of the baked good than traditional arrangements. As one non-limiting example, the invention relates to an arrangement of portions that, once baked, form a substantially central connection that links each of said portions to one another. The invention further relates to baking molds that enables the formation of said consistent pull-apart multi-portion baked goods. Additionally, the invention includes methods of making said pull-apart multi-portion baked goods and said baking mold.

### FIELD OF TECHNOLOGY

The present invention relates to the formation of pull-apart multi-portion baked goods composed of multiple portions of dough or thick batter, including, but not limited to, bread dough or muffin batter. Specifically, the invention relates to a pull-apart multi-portion baked good developed by arranging the multiple portions of dough or batter such that the baking process creates minimal connections linking said portions and thus obtains better consistency among each portion of the baked good compared to traditional arrangements. As one non-limiting example, the invention relates to an arrangement of portions that, once baked, form a substantially central connection that links each of said portions to one another. The invention further relates to baking molds that enables the formation of said consistent pull-apart multi-portion baked goods. Additionally, the invention includes methods of making said pull-apart multi-portion baked goods and said baking mold.

### BACKGROUND

Baked goods that utilize leavening agents, such as yeast or chemical leavening, form dough or thick batter that expands upon exposure to heat as part of the baking process. This expansion of such dough or batter must be controlled to form decorative shapes of the baked goods or to achieve certain results, such as consistency among all edges of the baked goods.

One characteristic of all baked goods that utilize leavening agents, and bread dough in particular, is that they will develop loose connections with other portions of the baked good if placed in close proximity to other portions prior to baking. Whether, and the degree to which, each of the portions of a baked good are connected to one another as part of the baking process is a function of the characteristics of the dough or batter, including the degree of expansion of the dough or batter upon baking, the distances between the portions of dough or batter vis-à-vis one another, and the arrangement of the portions of dough or batter prior to baking.

Loose connections between each of the portions of dough or batter are unfavorable if the baker desires separate baked goods, for example, with cookies or donuts. Loose connections between portions of dough or batter also are not preferred if the baker desires consistency in the appearance, texture, taste, and mouth-feel of each portion—the exposed edges, i.e., the edges that are not connected to other portions of dough or batter, develop a crust that is crunchy, golden, caramelized, and/or is baked more thoroughly compared to the edges that abut and connect with other dough or batter portions.

The tendency of dough or batter to develop loose attachments or connections can be an advantage, however, when it is desirable to make or sell the portions in bulk. Commercial bakers use the expansive nature of dough and batter to create interconnected multi-portion baked goods that can be packaged and sold as one unit. The purchaser of said product then pulls apart a portion of the multi-portion baked good.

Traditionally, pull-apart multi-portion baked goods are sold as sheets, i.e., rectangular, round, or square arrangements of the individual portions. Examples of such traditional pull-apart multi-portion baked goods include dinner rolls, danishes, cinnamon rolls, scones, and biscuits.

In the traditional pull-apart multi-portion baked good, each portion is connected to the other portions along the entire length of the good and often along two or more edges. With pull-apart multi-portion baked goods, the portions differ in appearance, texture, taste, and mouth-feel depending on their location within the sheet. Corner portions have two edges that formed a connection with other portions and two edges that are exposed; non-corner portions on the outer side of the sheet have three edges that are connected to the other portions with only one exposed edge; and portions in the center of the sheet have all four edges forming connections with other portions. As noted previously, exposed edges of dough or batter develop a crust that is crunchy, golden, caramelized, and/or is baked more thoroughly due to its closer exposure to the sides of the baking mold or to the heated air. Standard pull-apart multi-portion baked goods thus provide an inconsistent consumer experience. Additionally, in most multi-portion baked goods, the appearance, texture, taste, and mouth-feel of the product depends upon which portion is selected.

There is a need for pull-apart multi-portion baked goods that provide a more consistent consumer experience. In particular, there is a need for pull-apart multi-portion baked goods that have more consistent edge characteristics as to each portion and/or where the portion chosen does not adversely affect the tasting experience of the consumer. There is further a need for baking molds that enable the production of such a pull-apart multi-portion baked good, as well as methods of making said pull-apart multi-portion baked goods and said baking molds.

### SUMMARY

The present invention encompasses pull-apart multi-portion baked goods, baking molds for said goods, and methods of making said goods.

According to one embodiment of the pull-apart multi-portion baked good, each individual or separable portion is arranged such that they connect to one another in a minimal manner and easily separated by hand. As non-limiting embodiments, each of the individual portions can radiate outward from a single focal point. For example, each of the individual portions can be connected at a substantially central location. As another non-limiting example, each of the individual portions can be connected at one location that is off-center.

In another non-limiting embodiment, the individual portions can be connected to form a radiating ring where the outer edges and most of the side edges are not connected to the other portions. In this embodiment, a holder can be placed in the hole or void formed by the radiating ring to hold, e.g., dips, glazes, cheeses, butters or flavored butters, creams, jams, jellies, preserves, flavor inclusions, sugars (granular, powdered, colored, or glittered), nut butters, peanut butters, caramels, syrups, frostings, fruits, vegetables, nuts, flowers, and/or other edible or decorative accompaniments to the pull-apart multi-portion baked goods. Alternatively, the hole or void formed by the radiating ring itself may hold the accompaniments to the pull-apart multi-portion baked goods.

The pull-apart multi-portion baked good of the present invention is scalable in that the finished good may be considered single serving and thus each portion of the good is a partial serving and/or “bite-sized.” Alternatively, the pull-apart multi-portion baked good can be sized so that each portion is a single serving or more, i.e., designed for multiple people or multiple meals.

Preferably, for each portion of the inventive pull-apart multi-portion baked goods, the surface area of the edges of that portion that are connected to another portion is between approximately 5% to 75% of the total surface area of the edges of the portion. Correspondingly, for each portion of the inventive pull-apart multi-portion baked goods, the surface area of the exposed edges of that portion preferably consists of between approximately 25% to 95% of the total surface area of the edges of the portion. In preferred embodiments, the surface area of the edges of each portion that are connected to another portion comprise 75%, 70%, 65%, 60%, 55%, 50%, 45%, 40%, 30%, 20% 10%, and 5% of the total surface are of the edges of the portion. Correspondingly, in preferred embodiments, the surface area of the exposed edges of each portion comprise 25%, 30%, 35%, 40%, 45%, 50%, 55%, 60%, 70%, 80% 90%, and 95% of the total surface are of the edges of the portion.

In certain embodiments, the pull-apart multi-portion baked goods are comprised of three portions, four portions, five portions, six portions, seven portions, eight portions or more. The size of each portion within the pull-apart multi-portion baked good can be identical or may vary. As non-limiting examples, all portions could be the same size to ensure that all consumers receive identically sized portions. As another non-limiting example, small-sized portions could be mixed with large-sized portions within the same pull-apart multi-portion baked good to form, i.e., adult- and child-sized portions. Further, three, four, or more portion sizes could be included to provide a variety of choices for the consumer. As another non-limiting example, the pull-apart multi-portion baked good could contain such various portion sizes such that no portion is the same size. The arrangement of different-sized portions in the pull-apart multi-portion baked goods can be symmetrical or asymmetrical.

In another embodiment, the pull-apart multi-portion baked goods can be colored, by dye or by virtue of their ingredients. In one embodiment, all portions of the pull-apart multi-portion baked goods are comprised of a single color of dough or batter. Alternatively, the pull-apart multi-portion baked goods may be comprised of dough or batter that is composed of two different colors, three different colors, four different colors, five different colors, or more. In another alternative, the pull-apart multi-portion baked goods may be comprised of dough or batter that is composed of different shades of the same color, for example, light purple and dark purple, or an array of different tones of the same basic color, for example, a pull-apart multi-portion baked good comprised of dough or batter where the portions are aqua blue, teal blue, turquoise, cobalt, royal blue, and/or navy blue.

In one contemplated embodiment, the pull-apart multi-portion baked goods are comprised of multiple portions that have the same general shape. Alternatively, the pull-apart multi-portion baked goods may be comprised of portions that have different shapes. Non-limiting examples of shapes that may be used for portions of the pull-apart multi-portion baked good include one or more of the following: petal-shapes, including but not limited to the shapes associated with hibiscus flowers, sunflowers, daisies, plumeria, petunias, roses, peonies, and/or cherry blossoms; leaf-shapes, including but not limited to leaves associated with clover, grasses, fronds, flowers, and/or trees; geography-shapes, including but not limited to the shapes of the Hawaiian islands; animal-shapes, including but not limited to full animals, animal tails, animal paws, animal heads, animal rears, and/or animal ears; fruit and/or vegetable shapes, including but not limited to pineapples, bananas, berries, carrots, and/or cucumber; crown-shapes; surfboard-shapes; circular or oval-shapes; substantially triangular shapes, including but not limited to star arms and/or pointed sun rays; and/or substantially tetrahedral shapes, including but not limited to pyramids and/or stylized rectangular or tetrahedral sun rays.

In certain embodiments, the pull-apart multi-portion baked goods are comprised of a single dough or batter variety. In other embodiments, the types of dough and/or batters within the pull-apart multi-portion baked good may differ and include two, three, four, five, or more dough and/or batter varieties. In other embodiments, the density of the dough or batter for the pull-apart multi-portion baked good also may differ, with some portions using a denser dough or batter, such as that used for hamburger buns, while other portions use a less dense dough or batter, such as that used for dinner rolls.

Examples of dough that can be used for the present invention includes, but is not limited to, sweet bread dough, sour bread dough, white bread dough, wheat bread dough, nut bread dough, gluten-free bread dough, rye bread dough, Hawaiian bread dough, pretzel dough, puff pastry dough, artisan bread dough, bagel dough, brioche dough, flavored doughs, corn bread dough, and/or marbled mixes or compilations of two or more doughs. Examples of batters that can be used for the present invention include, but are not limited to, muffin batters, waffle batters, cake donut batters, pancake batters, cookie batters, and/or any thick batter that can form dividable portions of a multi-portion baked good that can be pulled apart after baking.

The dough or batter used for each portion of the pull-apart multi-portion baked goods may optionally include one or more of the following additives: extracts, liquors, coffees and/or spices, including but not limited to food coloring, vanilla flavoring, mint extract, mocha, coffee, cinnamon, nutmeg, allspice, rum, champagne, whiskey, and/or beer; chips, chunks, and/or streaks of traditional dessert additives, including but not limited to chocolate, peanut butter, toffee, caramel, and/or butterscotch; fruits in whole, part, and/or juice form, including but not limited to berries, apples, oranges, pineapples, mangoes, cherries, and/or bananas; nuts, legumes, and/or seeds, including but not limited to tree nuts, peanuts, chia seeds, flax seeds, pumpkin seeds, and/or sunflower seeds; and/or savory components, including but not limited to bacon flavoring or bits, smoked meats, cheeses, vegetables, and/or mushrooms. Additional additives to the dough or batter may include energy boosting, medicinal, and/or herbal components, including but not limited to caffeine, Echinacea, and/or vitamin C. In other embodiments, additives may include powdered substances, including but not limited to protein powders or mushroom powder. The above additives may be included as part of the pull-apart multi-portion baked goods in multiple ways, including but not limited to, by being integrated into the doughs or batters as flavoring and/or mixed into the doughs or batters as particulates, and/or by both incorporation methods; alternatively, the additives may be included as fillings, toppings, and/or coatings.

In other embodiments, each portion of the pull-apart multi-portion baked goods may optionally include fillings, toppings, and/or have coatings. In addition to the additives noted previously, non-limiting examples of fillings, toppings, and/or coatings for the portions include, but are not limited to, puddings, glazes, salts, frostings, brines, pretzels, candies, syrups, sauces, creams, cheeses, meats, spices, jams, jellies, butters, nut butters, peanut butter, schmears, guacamole, cinnamon-based fillings or toppings, sugar-based fillings or toppings, sprinkles, maltodextrine-based powders, yogurts, hummus, dairy spreads, dressings, and/or dips such as onion dip, ranch dip, cheese dip, bean dip, vegetable spreads, and/or dips of the consumer's choosing. The fillings, toppings, and/or coatings for certain embodiments can be added pre- or post-baking. Each portion of the pull-apart multi-portion baked goods can have the same fillings and/or toppings or can have two, three, four, five, six, seven, eight or more different fillings and/or toppings, or combinations of fillings and toppings. The fillings can be added through various mechanisms, including but not limited to piping, spooning, layering, enrobing, encrusting, and/or injecting one or more fillings. The toppings and/or coatings can be applied, as non-limiting examples, as a drizzle, as a frosting, as a glaze, and/or as a thin or thick coating on top and/or on all exposed sides. As other contemplated alternatives, the toppings and/or coatings can be applied as an infusion, by soaking, encrusting and/or by enrobing one or more portions of the multi-portion baked good.

In other embodiments, each portion of the pull-apart multi-portion baked goods may optionally include layers within one or more single portions, including but not limited to one, two, three, four, and/or five or more layers within each portion. As another alternative embodiment, the layers may contain different additives within the bread or dough components; for example, a portion of the pull-apart multi-portion baked good may include one layer that is spiced bread dough and a second layer that is the same spiced bread dough but that also contains fruit particulates. As yet another embodiment, the layers may contain a mixture of different types of doughs or batters; for example, a layer of a Hawaiian bread dough may be sandwiched between two pretzel doughs. In other embodiments, fillings, toppings, or coatings may divide the layers.

In the baking process for the pull-apart multi-portion baked good, each portion of dough or batter should be arranged with respect to the others by taking into account the expansion characteristics of the dough or batter. The desired proximity of the individual portions of dough or batter to one another can be easily determined by a person of ordinary skill in the art and routine experimentation as needed. Such proximity may depend upon factors including but not limited to the dough or batter used, e.g., the amount of leavening agent, salt, fat, emulsifiers, surfactants, oxidants, and/or water content in the dough or batter, the fillings, layers, and/or coatings associated with the unbaked portions, the amount or density of dough or batter used, the temperature at which the dough or batter is baked, and/or the length of time that the dough or batter is baked.

The invention also includes baking molds that facilitate the development of the pull-apart multi-portion baked goods described above. One non-limiting embodiment of the baking mold contains cavities that receive portions of dough or batter and are positioned such that the dough or batter portions, upon baking, are connected at a substantially central location. Alternatively, the individual portions can be connected, upon baking, at one location that is off-center. In another non-limiting embodiment, the cavities of the baking mold may position individual portions of dough or batter such that they form a radiating ring upon baking where the outer edges and most of the side edges are not connected to the other portions. Optionally, to facilitate the connections between the individual portions of dough, the depth of the cavities within the baking mold may be shallower where the connections are desired as compared to other locations within the baking mold, such as the sides of the mold, to assist in pulling the portions apart easily. Alternatively, the bottom and/or sides of the baking mold cavities may optionally contain divots or dividers to keep the individual portions of the dough or batter from moving during the baking process.

In one embodiment of the baking mold for the pull-apart multi-portion baked goods, the baking mold is made of one or more of the following materials: plastics, ceramics, silicon-containing materials, metals, rubbers, polymers, paperboard, and/or glass. In another embodiment, the baking mold is a bake-able plastic that permits the product to be baked or reheated in the baking mold. In another embodiment of the baking mold, the baking mold may have coatings including but not limited to a non-stick coating, such as, e.g., ceramic coatings, polytetrafluoroethylene coatings, and/or coatings of oil or mineral oil, or a coating that indicates temperature changes or “doneness,” such as by color changes or conformational changes.

In certain embodiments, the baking mold comprises a single mold that produces one pull-apart multi-portion baked good. Such an embodiment is particularly useful for larger versions of the pull-apart multi-portion baked goods, including but not limited to multi-serving or family-sized baked goods where each portion is one or more servings of the baked good. In other embodiments, the baking mold comprises two, three, four, five, six, or more molds combined together with each mold capable of making a single pull-apart multi-portion baked good. Such an embodiment is particularly useful for making smaller versions of the pull-apart multi-portion baked goods, including but not limited to single-serving or individual baked goods where each portion is bite-sized or only a partial serving of the baked good.

The invention further includes methods of making pull-apart multi-portion baked goods. In certain embodiments of the method of making pull-apart multi-portion baked goods, the method may comprise placing or filling the cavities of the baking mold with individual portions of dough or batter in which the baking mold is specially configured to minimize the connections among the goods and maximize the free edges of each portion, such as, for example, by positioning the cavities. Another step of certain embodiments of the method may be to (a) freeze the pull-apart multi-portion baked goods; (b) bake the pull-apart multi-portion baked goods; or (c) partially bake or par-bake, rather than fully bake, the pull-apart multi-portion baked goods. With respect to embodiments of methods involving fully baking or partially baking pull-apart multi-portion baked good embodiments, such goods may be allowed to cool after the baking process is complete. As additional steps, the pull-apart multi-portion baked goods may be prepared and/or packaged, for example individually, in small batches, or in bulk, and then may be shipped and/or sold to consumers or customers, who finish the cooking process, for frozen or partially baked items, or reheating if desired for fully baked items.

The above steps may be augmented by optional steps and processes as described in further detail below. For example, in some embodiments of the method, the dough or batter may be proofed, fermented, and/or allowed to rest, rise, blossom, and/or undergo leavening processes; such processes may occur prior to the placement of the dough or batter into the mold, after the dough or batter is placed in the mold, and/or prior to or following any of the baking steps by the manufacturer, consumer, or customer. Other embodiments of the method of the invention comprise placing one, two, three, four, or more layers of dough or batter to form each portion of the pull-apart multi-portion baked goods prior to the baking process, thus creating portions having layers. Additionally, the method may include adding the step of coating or topping one or more portions of dough or batter prior to, during, and/or following the baking process; the baking mold may also be prepared prior to, during, and/or following the baking process by, as non-limiting examples, heating, cooling, coating, adding dividers or divots, or the like. A further embodiment of the method contemplates adding filling(s) to one or more portions of dough or batter prior to and/or after the baking process by methods including but not limited to injection said filling(s), folding said filling(s) into the dough or batter, and/or spreading, sputtering, spooning, encrusting, enrobing, injecting or otherwise applying filling(s) between two or more layers of dough or batter.

### BRIEF DESCRIPTION OF THE DRAWINGS

The features, nature, and advantages of the present disclosure will become more apparent from the detailed description set forth below when taken in conjunction with the drawings which correspond to the same.

FIG. 1 illustrates an example of the pull-apart multi-portion baked good where the portions are connected at a single focal point located substantially in the center of the baked good.

FIG. 2 illustrates an example of the pull-apart multi-portion baked good where the portions are connected in a radiating ring structure and a holder is used for dips or the like.

FIGS. 3-5 illustrate examples and features of the baking molds useful for forming the pull-apart multi-portion baked good shown in FIG. 1.

FIG. 6 illustrates an example of a method of making the pull-apart multi-portion baked goods as contemplated by this patent application.

### DETAILED DESCRIPTION OF EMBODIMENTS

Reference will now be made in detail to the embodiments of the present disclosure, examples of which are illustrated in the accompanying drawings. The reference numerals used in the detailed description of the embodiment below correspond to the reference numerals used in the accompanying drawings.

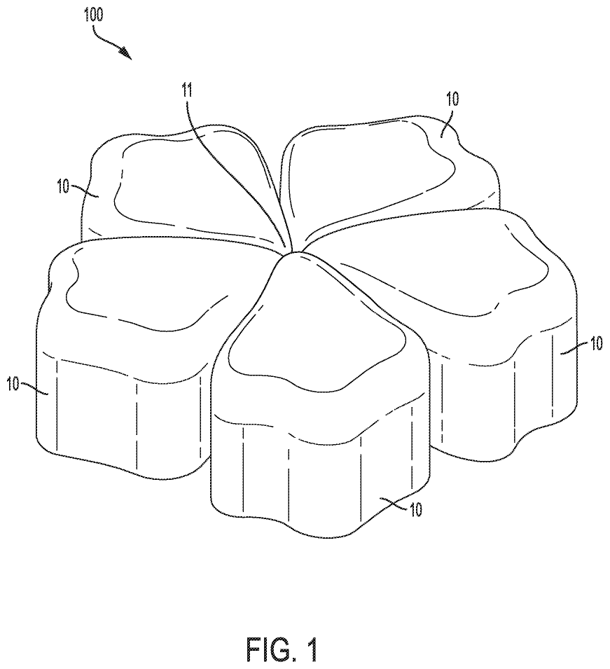

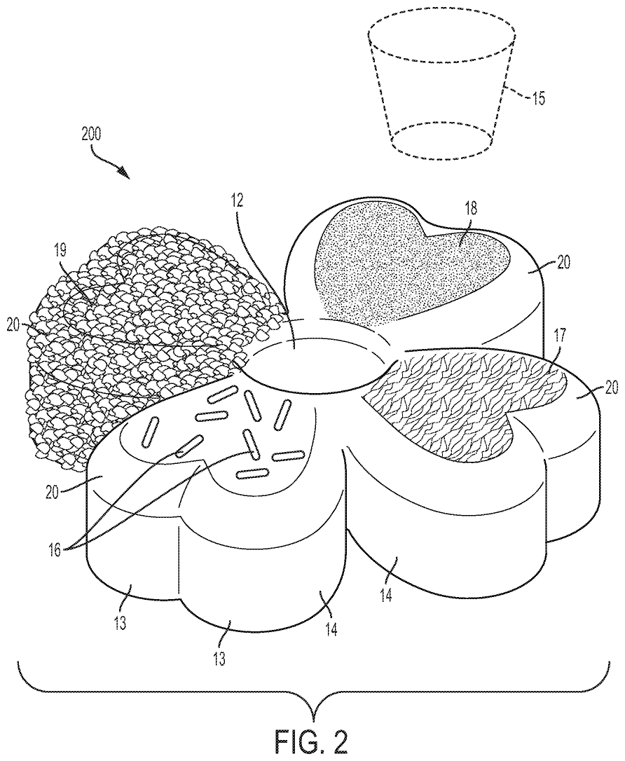

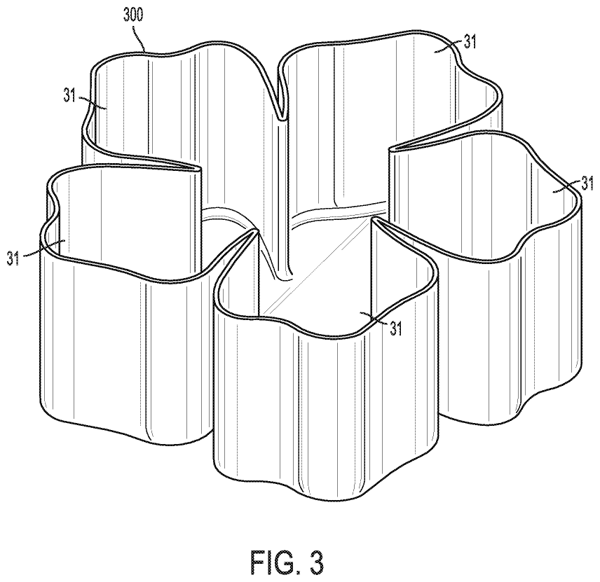

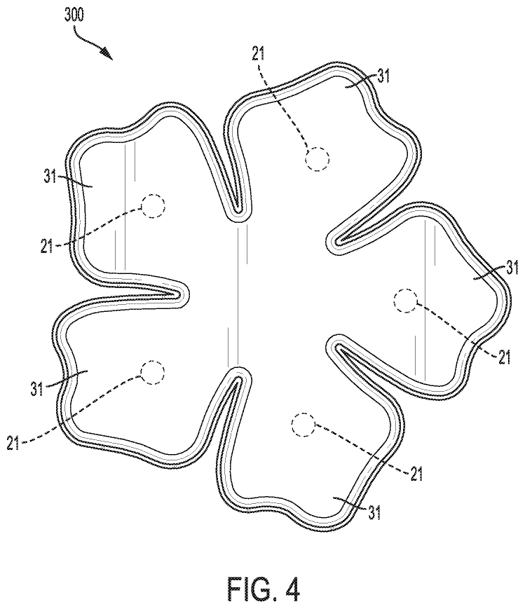

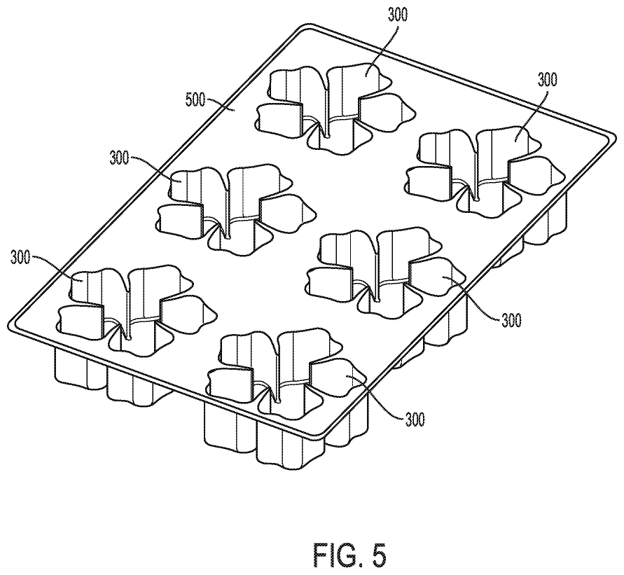

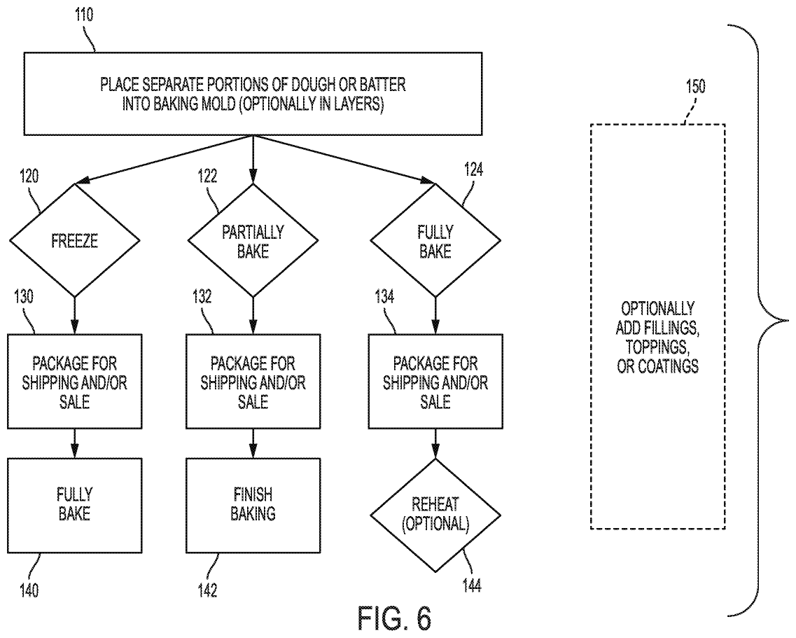

The present invention encompasses embodiments of a pull-apart multi-portion baked good, as depicted in FIG. 1 and FIG. 2, as well as molds for such goods, shown in FIG. 3, FIG. 4, and FIG. 5, and an illustrative method of making such pull-apart multi-portion baked goods, as described in FIG. 6. FIGS. 1-6 depict exemplary, non-limiting embodiments of the inventions set forth herein.

FIG. 1 depicts an example of the pull-apart multi-portion baked good 100 where each portion 10 is connected at a single focal point 11 located substantially in the center of the baked good. In FIG. 1, the pull-apart multi-portion baked good has five portions where each portion 10 is identical and is of an asymmetrical hibiscus petal shape.

While FIG. 1 depicts a pull-apart multi-portion baked good 100 connected at a single focal point 11 located substantially in the center of the baked good, a second preferred embodiment, not shown, may comprise multiple portions connected at a single focal point that is located off-center.

In another preferred embodiment, the portions can be connected to form a radiating ring where the outer edges and most of the side edges are not connected to the other portions, as shown in FIG. 2. FIG. 2 depicts a pull-apart multi-portion baked good 200 that is connected so as to form a radiating ring around a void or hole 12. The outer edges 13 and the side edges 14 of each portion 20 are mostly not connected to other portions of the pull-apart multi-portion baked good 200. In FIG. 2, the pull-apart multi-portion baked good 200 has four portions where each portion 20 is identical and is in the shape of a symmetrical clover leaf. FIG. 2 also depicts an example of a holder 15 that preferably can be placed into the hole 12 formed by the radiating ring. Preferably, the holder 15 or, in an alternative preferred embodiment, the hole 12, can be filled with a variety of condiments and accompaniments to the baked good. The holder 15 may also be added separately to the baked good 100 shown in FIG. 1.

Preferred examples of condiments and accompaniments for the holder 15 or hole 12 include dips, glazes, cheeses, butters or flavored butters, creams, jams, jellies, preserves, flavor inclusions, sugars (granular, powdered, colored, or glittered), nut butters, peanut butters, caramels, syrups, frostings, and/or other edible or decorative accompaniments to the pull-apart multi-portion baked goods 100/200.

The pull-apart multi-portion baked goods 100/200 are preferably scalable in size. In one preferred embodiment, the pull-apart multi-portion baked good 100/200 is a single serving or individual snack with each portion 10/20 being a partial serving and/or “bite-sized.” Alternatively, the pull-apart multi-portion baked goods 100/200 can be sized so that each portion 10/20 is a single serving or two servings or even more, such as what would be appropriate for a group or family or for multiple meals/uses.

Preferably, the size of each portion within the pull-apart multi-portion baked is identical, as depicted in FIGS. 1-2, so as to ensure that all consumers receive identically sized portions. In another preferable embodiment, not shown, small-sized portions could be mixed with large-sized portions within the same pull-apart multi-portion baked good to form adult- and child-sized portions. Another preferred embodiments, also not shown, would have a mixture of three or more portion sizes to provide a variety of size choices for the consumer.

Preferred embodiments include pull-apart multi-portion baked goods with five portions, as indicated in FIG. 1, or four portions, as indicated in FIG. 2. Alternative preferred embodiments not shown may have six, seven, eight, or more portions.

In one contemplated preferred embodiment, the pull-apart multi-portion baked goods are comprised of multiple portions that have the same general shape, as shown in both FIG. 1 and FIG. 2. Not shown are alternative preferred embodiments that include pull-apart multi-portion baked goods where the portions have different shapes. Non-limiting examples of shapes that may be used for portions of the pull-apart multi-portion baked good include one or more of the following: petal-shapes, including but not limited to the shapes associated with hibiscus flowers, as shown in FIG. 1, sunflowers, daisies, plumeria, petunias, roses, peonies, and/or cherry blossoms; leaf-shapes, including but not limited to leaves associated with clovers, as shown in FIG. 2, grasses, fronds, flowers, and/or trees; geography-shapes, including but not limited to the shapes of the Hawaiian islands; animal-shapes, including but not limited to full animals, animal tails, animal paws, animal heads, animal rears, and/or animal ears; fruit and/or vegetable shapes, including but not limited to pineapples, bananas, berries, carrots, and/or cucumber; crown-shapes; surfboard shapes; substantially circular or substantially oval shapes; substantially triangular shapes, including but not limited to star arms and/or pointed sun rays; and/or substantially tetrahedral shapes, including but not limited to pyramids and/or stylized rectangular or tetrahedral sun rays.

In some preferred embodiments, the shapes of each portion may be asymmetrical, as depicted in FIG. 1, while in other preferred embodiments, the shapes of each portion may be symmetrical, as depicted in FIG. 2. In yet further preferred embodiments, not shown, the baked good can contain a mixture of symmetrical- and asymmetrical-shaped portions.

In another preferred embodiment, the pull-apart multi-portion baked goods are comprised of a single color of dough or batter, where said color is derived from dyes or the ingredients composing the dough or batter. Other preferred embodiments include pull-apart multi-portion baked goods that are comprised of dough or batter of two different colors, three different colors, four different colors, five different colors, or more. In other preferred embodiments, the pull-apart multi-portion baked goods may be comprised of dough or batter that is composed of different shades of the same color or different tones of the same basic color.

Preferably, the pull-apart multi-portion baked goods are comprised of a single dough or batter variety. In other preferred embodiments, the types of dough and/or batters within the pull-apart multi-portion baked good may differ and include two, three, four, five, or more dough and/or batter varieties. In still other preferred embodiments, the density of the dough or batter for the pull-apart multi-portion baked good also may differ, with some portions containing a denser dough or batter, such as that used for hamburger buns, while other portions use a less dense dough or batter, such as that used for dinner rolls.

Examples of dough that can be used for the present invention include, but are not limited to, sweet bread dough, sour bread dough, white bread dough, wheat bread dough, nut bread dough, gluten-free bread dough, rye bread dough, Hawaiian bread dough, pretzel dough, puff pastry dough, artisan bread dough, bagel dough, brioche dough, flavored doughs, corn bread dough, and/or marbled mixes or compilations of two or more doughs. One example of a preferred dough is Hawaiian bread dough. Examples of batters that can be used for the present invention include, but are not limited to, muffin batters, waffle batters, cake donut batters, pancake batters, cookie batters, and/or any thick batter that can form dividable portions of a multi-portion baked good that can pull-apart after baking. One example of a preferred batter is a waffle batter.

In certain preferred embodiments, the dough or batter used for each portion of the pull-apart multi-portion baked goods 100/200 shown in FIGS. 1-2 include one or more of the following additives: extracts, liquors, coffees and/or spices, including but not limited to food coloring, vanilla flavoring, mint extract, mocha, coffee, cinnamon, nutmeg, allspice, rum, champagne, whiskey, and/or beer; chips, chunks, and/or streaks of traditional dessert additives, including but not limited to chocolate, peanut butter, toffee, caramel, and/or butterscotch; fruits in whole, part, and/or juice form, including but not limited to berries, apples, oranges, pineapples, mangoes, cherries, and/or bananas; nuts, legumes, and/or seeds, including but not limited to tree nuts, peanuts, chia seeds, flax seeds, pumpkin seeds, and/or sunflower seeds; and/or savory components, including but not limited to bacon flavoring or bits, smoked meats, cheeses, vegetables, and/or mushrooms. Additional preferred additives to the dough or batter may include energy boosting, medicinal, and/or herbal components, including but not limited to caffeine, Echinacea, and/or vitamin C. In other preferred embodiments, additives may include powdered substances, including but not limited to protein powders or mushroom powder. The above preferred additives may be included as part of the pull-apart multi-portion baked goods in multiple ways, including but not limited to, by being integrated into the doughs or batters as flavoring and/or mixed into the doughs or batters as particulates, and/or by both incorporation methods; alternatively, the additives may be included as fillings, toppings, and/or coatings. For example, FIG. 2 shows four types of toppings or coatings on the tops of each portions 20, including sprinkles 16, a glaze 17, a frosting 18, and an encrustment 19.

Preferably, each portion of the pull-apart multi-portion baked goods 100/200 may optionally include fillings, toppings, and/or have coatings. In addition to the additives noted previously, non-limiting examples of preferred fillings, toppings, and/or coatings for the portions include, but are not limited to, puddings, glazes 17, salts, frostings 18, brines, pretzels, candies, syrups, sauces, creams, cheeses, meats, spices, jams, jellies, butters, nut butters, peanut butter, schmears, guacamole, cinnamon-based fillings or toppings, sugar-based fillings or toppings, sprinkles 16, maltodextrine-based powders, yogurts, humus, dairy spreads, dressings, and/or dips such as onion dip, ranch dip, cheese dip, bean dip, vegetable spreads, and/or consumer added dips. The fillings, toppings, and/or coatings for certain preferred embodiments can be added pre- or post-baking. Each portion of the pull-apart multi-portion baked goods 100/200 can have the same fillings and/or toppings or can have two, three, four, five, six, seven, eight or more different fillings and/or toppings, or combinations of fillings and toppings. The fillings preferably can be added through various mechanisms, including but not limited to piping, spooning, layering, enrobing, encrusting, and/or injecting one or more fillings. The toppings and/or coatings can be preferably applied, as non-limiting examples, as a drizzle, as a glaze 17, as a frosting 18, on the top of a portion, and/or as a thin or thick coating on top and/or on all exposed sides. As another alternative preferred embodiment, the toppings and/or coatings can be applied as an infusion, by soaking, by encrusting 19, and/or by enrobing one or more portions of the multi-portion baked good 100/200. One example of a preferred topping or coating is using pretzel coating and/or a pretzel brine. One preferred filling is a pudding, preferably mango or pineapple. Another preferred filling is using peanut butter with or without jelly.

In other preferred embodiments, each portion of the pull-apart multi-portion baked goods may optionally include layers within one or more single portions, including but not limited to one, two, three, four, and/or five or more layers within each portion. As another alternative embodiment, the layers may contain different additives within the bread or dough components; for example, a portion of the pull-apart multi-portion baked good 100/200 may include one layer that is spiced bread dough and a second layer that is the same spiced bread dough but also contains fruit particulates. An yet another preferred embodiment, the layers may contain a mixture of different types of doughs or batters. In one preferred embodiment, a layer of a Hawaiian bread dough may be sandwiched between two pretzel doughs. In other preferred embodiments, fillings, toppings, or coatings may divide the layers within each portion 10/20.

The present invention also includes baking molds for the pull-apart multi-portion baked goods 100/200 of FIGS. 1-2. FIGS. 3-5 illustrate baking molds capable of making the pull-apart multi-portion baked good 100 of FIG. 1. In FIG. 3, a single baking mold containing five cavities is shown for a five-portion pull-apart baked good where each portion is identical in size and in the shape of an asymmetrical hibiscus leaf. Preferably, the baking mold is made of one or more of the following materials: plastics, ceramics, silicon-containing materials, metals, rubbers, polymers, paperboard, and/or glass. In another preferred embodiment, the mold is a bake-able plastic mold wherein the pull-apart multi-portion product 100 is baked in the mold within which it is sold. In another preferred embodiment of the baking mold for the pull-apart multi-portion baked goods, the baking mold may have coatings including but not limited to a non-stick coating, such as, e.g., ceramic coatings, polytetrafluoroethylene coatings, and/or coatings of oil or mineral oil, or a coating that indicates temperature changes or “doneness,” such as by color changes or conformational changes.

One of the preferred embodiments of the baking mold 300 is shown in FIG. 3, where the cavities of the baked mold 31 are positioned so that each of the portions of the pull-apart baked good will radiate outward from a single focal point located at a substantially central location upon baking. In another preferred embodiment, not shown, the cavities of the baked mold may be positioned that each of the portions of the pull-apart baked good will be connected, upon baking, at one location that is off-center. In another non-limiting preferred embodiment, not shown, the baking mold may contain cavities that position each of the portions to form a radiating ring upon baking where the outer edges and most of the side edges are not connected to the other portions.

An additional preferred embodiment of the baking mold 300 of FIG. 3 is shown in FIG. 4. In FIG. 4, the bottom of the baking mold 300 is visible and optional divots 19 are included within each cavity 31, as shown in dashed lines. The divots 19, which can be located on the bottom or on the sides of the baking mold 300, keep the individual portions of the dough or batter from moving during the baking process. Other preferred modifications to the baking mold, not shown, include varying the depth of the cavities of the baking mold so that it is shallower where the connections are desired as compared to other locations within the baking mold, such as the sides of the mold. Still further preferred embodiments add dividers to the mold to better hold the portions of dough or batter within their desired cavities.

Preferably, the baking mold 300 for the pull-apart multi-portion baked goods is made of one or more of the following materials: plastics, ceramics, silicon-containing materials, metals, rubbers, polymers, paperboard, and/or glass. In another preferred embodiment, the baking mold 300 is a bake-able plastic mold where the pull-apart multi-portion good is sold within the mold in which it is to be baked. In other preferred embodiments of the baking mold 300, the baking mold 300 has a non-stick coating, such as, e.g., ceramic coatings, polytetrafluoroethylene coatings, and/or coatings of oil or mineral oil, or a coating that indicates temperature changes or “doneness,” such as by color changes or conformational changes.

In certain preferred embodiments, the baking mold 300 comprises a single mold that produces one pull-apart multi-portion baked good, as shown in FIGS. 3-4. Such preferred embodiments are particularly useful for larger versions of the pull-apart multi-portion baked goods, including but not limited to multi-serving or family sized baked goods where each portion is one or more servings of the baked good. In other preferred embodiments, such as that shown in FIG. 5, the baking mold 500 comprises two, three, four, five, six, or more baking molds 300 with each mold capable of making a single pull-apart multi-portion baked good. FIG. 5 is an example of a multi-mold baking mold 500 that has six baking molds 300, with each mold making a single pull-apart multi-portion baked good 100. Such a preferred embodiment is particularly useful for making smaller versions of the pull-apart multi-portion baked goods, including but not limited to single-serving or individual baked goods where each portion is “bite-sized” or only a partial serving of the baked good.

FIG. 6 provides an illustrative example of a preferred method of making the pull-apart multi-portion baked goods of the present invention. In step 110, each portion of dough or batter is placed in the separate cavities of the baking mold. Optionally, the dough or batter can be inserted into the mold in layers. After placement of the portions, there are at least three options for how to proceed. As one preferred option, the baking mold containing the dough or batter portions is frozen (step 120). The frozen pull-apart multi-portion baked good is then packaged (step 130) for shipping and sale. Upon purchase or receipt, the customer or the consumer fully bakes the frozen pull-apart multi-portion baked good (step 140). As a second preferred option, the baking mold containing the dough or batter portions is partially baked or “par-baked” (step 122). The partially baked pull-apart multi-portion baked good is then packaged (step 132) for shipping and sale. Upon purchase or receipt, the customer or the consumer finishes the baking process for the par-baked pull-apart multi-portion baked good (step 142). As a third preferred option the baking mold containing the dough or batter portions is fully baked (step 124). The fully baked pull-apart multi-portion baked good is then packaged (step 134) for shipping and sale. Upon purchase or receipt, either the customer or the consumer can choose to reheat the fully baked pull-apart multi-portion baked good (step 144) or enjoy it as is. As an optional step 150 in the process outlined in FIG. 6, the pull-apart multi-portion baked good can be filled, topped, and/or coated by the manufacture before, during, or after the placement stage (step 110), after the freezing or baking stages (step 120, step 122, or step 124), or the consumer or customer may fill, top, or coat the baked good before or after the final baking or optional reheating stages (step 140, step 142, or step 144). The steps set forth in FIG. 6 are not exclusive; the dough or batter may be proofed, fermented, and/or allowed to rest, rise, blossom, and/or undergo leavening processes and such processes may occur prior to the placement of the dough or batter into the mold, after the dough or batter is placed in the mold, and/or prior to or following any of the baking steps by the manufacturer, consumer, or customer. One of ordinary skill in the art will understand other baking, decorating, packaging, shipping, selling, displaying, and preparation steps can be easily incorporated into the method set forth by FIG. 6.

Although the present disclosure and its advantages have been described in detail, it should be understood that various changes, substitutions and alterations can be made herein without departing from the spirit and scope of the disclosure as defined by the appended claims. Moreover, the scope of the present application is not intended to be limited to the particular configurations of the process, machine, manufacture, composition of matter, means, methods and steps described in the specification. As one of ordinary skill in the art will readily appreciate from the present disclosure, processes, machines, manufacture, compositions of matter, means, methods, or steps, presently existing or later to be developed that perform substantially the same function or achieve substantially the same result as the corresponding configurations described herein may be utilized according to the present disclosure. Accordingly, the appended claims are intended to include within their scope such processes, machines, manufacture, compositions of matter, means, methods, or steps.

What is claimed is:

1) A pull-apart multi-portion baked good comprising two or more individual portions of said baked good wherein the individual portions connect to one another at a single focal point.

2) The pull-apart multi-portion baked good of claim 1 wherein the individual portions connect to one another at a substantially central location.

3) The pull-apart multi-portion baked good of claim 1 wherein the individual portions connect to one another at one location that is off-center within the pull-apart multi-portion baked good.

4) A pull-apart multi-portion baked good comprising:
two or more individual portions of said baked good,
wherein the individual portions connect to one another so as to form a radiating ring around a hole or void; and
wherein each portion has two opposing edges that are not connected to another portion.

5) The pull-apart multi-portion baked good of claim 4
wherein the hole or void formed by the radiating ring is filled with a holder; and
wherein said hole or void and/or said holder optionally is filled with edible or decorative accompaniments to the pull-apart multi-portion baked good,
wherein said edible or decorative accompaniments comprises dips, glazes, cheeses, butters or flavored butters, creams, jams, jellies, preserves, flavor inclusions, sugars, nut butters, peanut butters, caramels, syrups, frostings, fruits, vegetables, nuts, and/or flowers.

6) The pull-apart multi-portion baked good of claim 1 wherein one or more individual portions of said baked good has a shape, wherein such shape comprises petal-shapes, leaf-shapes, geography-shapes, animal-shapes, fruit shapes, vegetable shapes, crown-shapes, surfboard-shapes, substantially circular shapes, substantially oval shapes, substantially triangular shapes, and/or substantially tetrahedral shapes.

7) The pull-apart multi-portion baked good of claim 4 wherein one or more individual portions of said baked good has a shape, wherein such shape comprises petal-shapes, leaf-shapes, geography-shapes, animal-shapes, fruit shapes, vegetable shapes, crown-shapes, surfboard-shapes, substantially circular shapes, substantially oval shapes, substantially triangular shapes, and substantially tetrahedral shapes.

8) The pull-apart multi-portion baked good of claim 1 wherein one or more individual portions is made of dough or batter comprising sweet bread dough, sour bread dough, white bread dough, wheat bread dough, nut bread dough, gluten-free bread dough, rye bread dough, Hawaiian bread dough, pretzel dough, puff pastry dough, artisan bread dough, bagel dough, brioche dough, flavored doughs, corn bread doughs, marbled mixes of doughs, compilations of two or more doughs, muffin batters, waffle batters, cake donut batters, pancake batters, cookie batters, and/or compilations of two or more batters.

9) The pull-apart multi-portion baked good of claim 4 wherein one or more individual portions is made of dough or batter comprising sweet bread dough, sour bread dough, white bread dough, wheat bread dough, nut bread dough, gluten-free bread dough, rye bread dough, Hawaiian bread dough, pretzel dough, puff pastry dough, artisan bread dough, bagel dough, brioche dough, flavored doughs, corn bread doughs, marbled mixes of doughs, compilations of two or more doughs, muffin batters, waffle batters, cake donut batters, pancake batters, cookie batters, and/or compilations of two or more batters.

10) The pull-apart multi-portion baked good of claim 1 wherein one or more individual portions contains additives comprising extracts, liquors, coffees, spices, food coloring, chocolate, peanut butter, toffee, caramel, butterscotch, fruits, fruit juices, nuts, legumes, seeds, meats, cheeses, vegetables, mushrooms, energy boosting additives, medicinal additives, herbal additives, caffeine, Echinacea, vitamin C, protein powder, and/or mushroom powder.

11) The pull-apart multi-portion baked good of claim 4 wherein one or more individual portions contains additives comprising extracts, liquors, coffees, spices, food coloring, chocolate, peanut butter, toffee, caramel, butterscotch, fruits, fruit juices, nuts, legumes, seeds, meats, cheeses, vegetables, mushrooms, energy boosting additives, medicinal additives, herbal additives, caffeine, Echinacea, vitamin C, protein powder, and/or mushroom powder.

12) The pull-apart multi-portion baked good of claim 1 wherein one or more individual portions of said baked good contain fillings, are comprised of layers, have toppings, are coated, are enrobed, and/or are encrusted.

13) The pull-apart multi-portion baked good of claim 4 wherein one or more individual portions of said baked good contain fillings, are comprised of layers, have toppings, are coated, are enrobed, and/or are encrusted.

14) A baking mold having two or more cavities for receiving an individual portion of dough or batter within each such cavity; wherein each cavity is connected to each other within the mold; and wherein the cavities are positioned such that after baking the individual portions of dough or batter connect to one another at a single focus point or so as to form a radiating ring around a hole or void.

15) The baking mold of claim 14 wherein the single focus point is at a substantially central location within said baking mold.

16) The baking mold of claim 14 wherein the single focus point is located off-center within said baking mold.

17) The baking mold of claim 14 wherein the cavities of the baking mold contain divots or dividers.

18) The baking mold of claim 14 wherein the cavities of the baking mold contain divots or dividers.

19) A pull-apart multi-portion baked good produced by adding dough or batter to each cavity of the baking mold of claim 14 and contacting the filled baking mold with heat at a sufficient temperature and for a sufficient time to allow the individual portions of dough or batter to connect to one another.

20) A pull-apart multi-portion baked good produced by adding dough or batter to each cavity of the baking mold of claim 14 and contacting the filled baking mold with heat at a sufficient temperature and for a sufficient time to allow the individual portions of dough or batter to connect to one another so as to form a radiating ring around a hole or void.
